(19) United States
(12) Patent Application Publication
(10) Pub. No.: US 2015/0014937 A1
(43) Pub. Date: Jan. 15, 2015

(54) SEAL ASSEMBLY AND SHAFT THEREFOR

(71) Applicant: Rolls-Royce Corporation, Indianapolis, IN (US)

(72) Inventors: Chad A. Behrman, Hope, IN (US); Andrew D. Copeland, Greenwood, IN (US)

(21) Appl. No.: 14/145,301

(22) Filed: Dec. 31, 2013

Related U.S. Application Data
(60) Provisional application No. 61/774,436, filed on Mar. 7, 2013.

(51) Int. Cl. F16J 15/16; F16J 15/40; F16J 15/32

(52) U.S. Cl. CPC F16J 15/164; F16J 15/3204; F16J 15/40
USPC 277/351; 277/549; 216/41

(57) ABSTRACT

A fluid sealing assembly includes a shaft and a seal. The shaft includes a surface portion having a microstructural geometry. The seal has a radially flexible portion disposed in proximity to the surface portion having the microstructural geometry such that when the shaft is rotated a pressure differential is generated at the interface of the seal and the surface portion having the microstructural geometry that pushes or pulls fluid relative to the interface.

### CROSS REFERENCE TO RELATED APPLICATIONS

This application claims priority to and the benefit U.S. Provisional Patent Application Number 61/774,436, filed on Mar. 7, 2013, the disclosure of which is now expressly incorporated herein by reference.

### TECHNICAL FIELD

The present application relates to a seal assembly and, more particularly, but not exclusively, to a shaft having surface geometric characteristics that interact with a shaft seal.

### BACKGROUND

Providing a buffer of fluid such as air and/or oil to interfaces of sealing surfaces, for example between a shaft and a shaft seal, remains an area of interest. Some existing systems have various shortcomings, drawbacks, and disadvantages relative to certain applications. Accordingly, there remains a need for further contributions in this area of technology.

### SUMMARY

One embodiment of the present application is a fluid sealing assembly that includes a shaft having a microstructural geometry that generates a pressure differential at an interface with a seal to push or pull fluid relative to the interface.

Other embodiments include unique methods, systems, devices, and apparatus to provide for micro pump interaction at the interface of a shaft geometry and a shaft seal. Further embodiments, forms, objects, aspects, benefits, features, and advantages of the present application shall become apparent from the description and figures provided herewith.

### BRIEF DESCRIPTION OF THE FIGURES

Features of the application will be better understood from the following detailed description when considered in reference to the accompanying drawings, in which:

FIG. 1 shows a cross-section of a seal assembly according to an embodiment;

FIG. 2 shows a shaft and a shaft geometry according to an embodiment, enlarged to show the microstructural geometry in the surface of the shaft;

FIG. 3 shows a cross-section of a localized portion of the FIG. 2 shaft, as seen from the line 3-3 in FIG. 2, and enlarged to show the microstructural geometry in the surface of the shaft;

FIG. 4 shows the microstructural geometry in the surface of the FIG. 2 shaft;

FIGS. 5A and 5B show a microstructural geometry comprising slots having a positive slope and slots having a negative slope, respectively; and

FIG. 6 shows a flowchart of a method according to an embodiment.

### DETAILED DESCRIPTION

While the present invention can take many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications of the described embodiments, and any further applications of the principles of the invention as described herein, are contemplated as would normally occur to one skilled in the art to which the invention relates.

FIG. 1 shows a seal assembly 10 according to an embodiment. The seal assembly 10 can be used in any suitable application in which a shaft 12 extends through an opening 8 in a housing 20 and moves relative to the housing 20 for example by rotation about and/or translation along an axis 24. In one embodiment, the housing 20 comprises a housing of an accessory drive gearbox of an aircraft gas turbine engine, which transmits power from a shaft of the gas turbine engine to various components of the aircraft such as propellers, fuel pumps, hydraulic pumps, electric generators, etc. The seal assembly 10 is not limited to aircraft applications, and other embodiments are contemplated, For example, the seal assembly 10 can be utilized in industrial applications, power generation applications, pumping sets, naval propulsion and other applications known to one of ordinary skill in the art. Further, it will be appreciated that the term “aircraft” as used herein includes, but is not limited to, helicopters, airplanes, unmanned space vehicles, fixed wing vehicles, variable wing vehicles, rotary wing vehicles, unmanned combat aerial vehicles, tailless aircraft, hover crafts, and other airborne and/or extraterrestrial (spacecraft) vehicles,

The seal assembly 10 includes a shaft 12 and an annular shape seal 30 that can interact with each other to prevent or inhibit the passage of fluid through the interface of the shaft 12 and the inside diameter of the opening 18 in the housing 20, thus sealing for example the outside 20a of the housing 20 from the inside 20b of the housing 20. The shaft 12 can include metallic and/or non-metallic materials, for example, stainless steel, aluminum, titanium, and/or or a ceramic composite, for example. The seal 30 can include elastomeric materials, including natural rubber and/or synthetic rubber, polymeric materials, and/or composite materials, for example. The configuration of the seal 30 is based on the sealing requirements of an application, including consideration of for example the characteristics of fluid being sealed from passing through the opening 18, the material properties and configuration of the shaft 12 and the housing 20, and the pressure, temperature, and other environmental demands of the application. In the illustrative embodiment, the seal 30 comprises a seal having a radially flexible portion, such as a lip seal. The lip seal 30 serves to prevent or inhibit flow by pressing a lip portion 34 against and/or in close proximity to the rotating and/or translating shaft 12. The as-shown seal 30 comprises a single lip; in another form, the seal 30 can comprise a multiple lip design. In one form, the seal 30 can include a garter spring disposed in a recess within the body of the seal 30 and radially outside the Up portion 34 of the seal 30, to urge the seal 30 to a particular proximity relative to the housing 20 and/or shaft 12. In another form, the seal 30 can include a circumferential alignment ring that aligns the body of the seal 30 circumferentially with respect to the housing 20 and/or the shaft 12.

The shaft 12 and seal 30 interact to push or pull fluid such as air and/or oil at the interface of, or clearance between, the shaft 12 and seal 30. In the FIG. 1 embodiment, at the circumferential portion at which the shaft 12 and seal 30 interface, the shaft 12 includes a microstructural geometry 38 in its surface. The microstructural geometry 38 can include for example an arrangement of micro channels and/or micro grooves in the surface of the shaft 12. During rotation of the shaft 12, the microstructural geometry 38 can interact with the seal 30 to generate a localized fluid pressure differential having the effect of a micro fluid pump. In one embodiment, the localized fluid pressure differential, or micro fluid pump, serves to pump a buffer of fluid across the seal 30. Other embodiments are also contemplated. For example, in an embodiment, the micro fluid pump can additionally or alternatively serve to pump a buffer of fluid between the surfaces of the shaft 12 and seal 30 to aerodynamically and/or hydrodynamically lift off the seal 30 from the outside diameter of the shaft 12. In another embodiment, the micro fluid pump can additionally or alternatively serve to add a buffer fluid into the interface of the shaft 12 and seal 30. In a further embodiment, the micro fluid pump can additionally or alternatively serve to remove buffer fluid from the interface of the shaft 12 and seal 30.

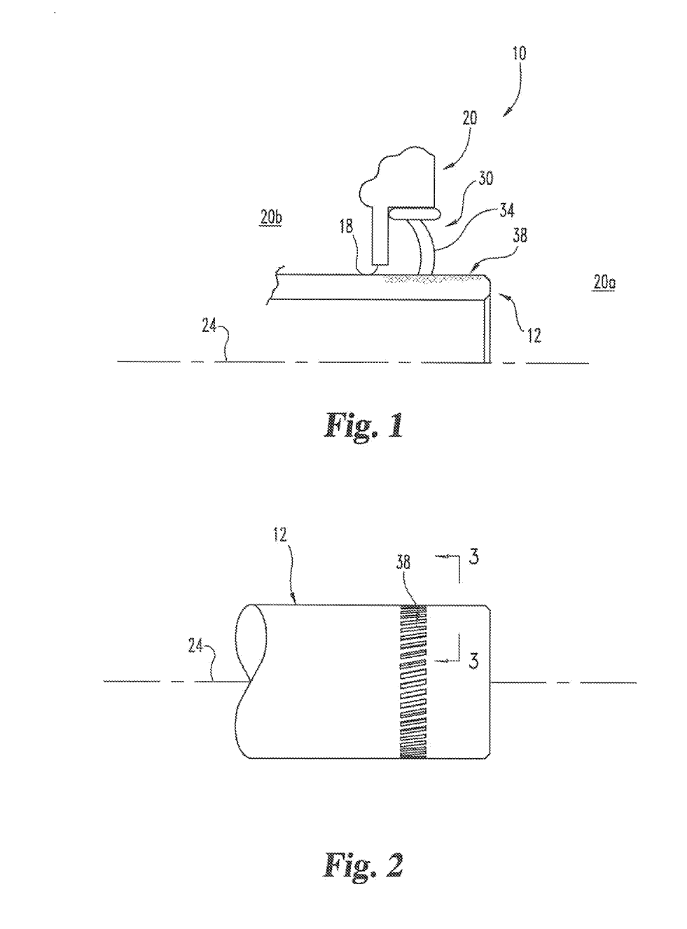

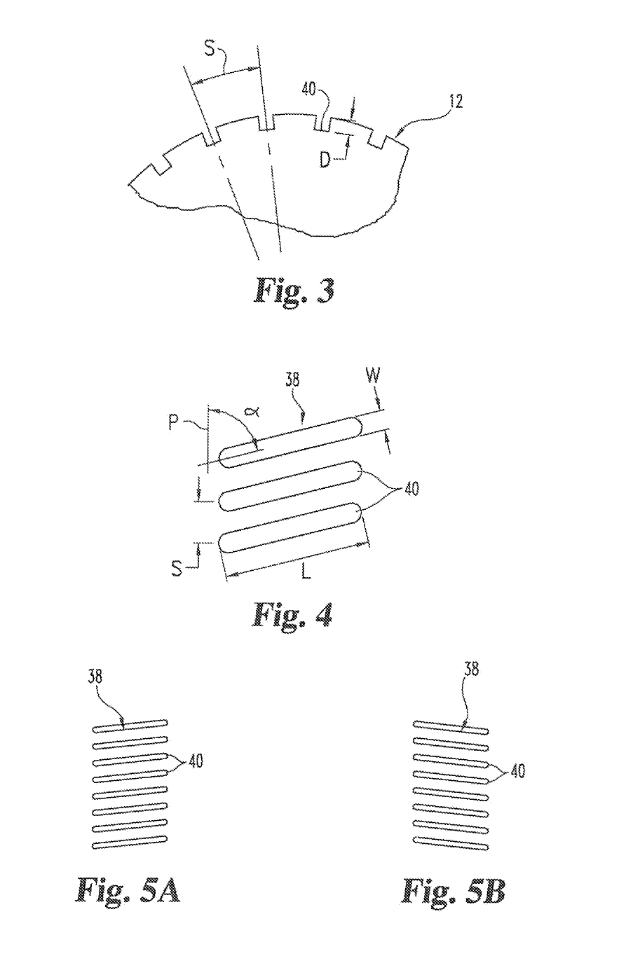

FIGS. 2 through 5 show a shaft 12 and a shaft microstructural geometry 38 according to an embodiment. In the illustrative embodiment, the shaft 12 has a microstructural geometry 38 in its surface that comprises a plurality of circumferentially spaced apart angled grooves or slots 40 formed for example by etching, to be described in greater detail below. FIG. 3 shows the depth D of the slots 40. The depth D can be substantially the same for all slots 40, as shown, or can differ from slot 40 to slot 40, or amongst different groups of slots 40, depending on the particular application of the seal assembly 10. FIGS. 2, 4, 5A, and 5B, show the angle alpha (α) at which the slots 40 are disposed relative to a plane P perpendicular to the axis 24 of the shaft 12. The angle α can depend on the direction of rotation of the shaft 12 and whether the seal assembly 10 is to seal the inside 20b or outside 20a of the housing 20. For example, for a given direction of shaft 12 rotation, for example clockwise, the slots 40 shown in the FIG. 5A microstructural geomety 38 have a positive slope to generate a micro pump action from the outside 20a to the inside 20b of the housing 20, whereas the slots 40 shown in the FIG. 5B microstructural geometry 38 have a negative slope to generate a micro pump action from the inside 20b to the outside 20a of the housing 20. Although the angle α is shown as being substantially the same for all slots 40, the microstructural geometry 38 need not be limited as such. Thus, for example, some slots 40 can be disposed at a first angle and some slots 40 disposed at a second angle that is different from the first angle.

FIG. 4 shows an enlarged localized portion of the microstructural geometry 38. As shown, the slots 40 are equally circumferentially spaced apart by a distance S. In another form, the slots 40 can be unequally spaced apart and/or can have a random distribution depending on the desired sealing and/or pumping characteristics of the seal assembly 10. Further, in the illustrative embodiment the slots 40 have the same width W and the same length L, although the microstructural geometry 38 need not be limited as such. As with the depth D, the width W and the length L can differ from slot 40 to slot 40, or amongst different groups of slots 40, depending on the particular application of the seal assembly 10. In the FIG. 4 embodiment, the slots 40 have a somewhat elongated shape in the axial direction of the shaft 12. The slots 40 can have any shape depending on the application of the seal assembly 10.

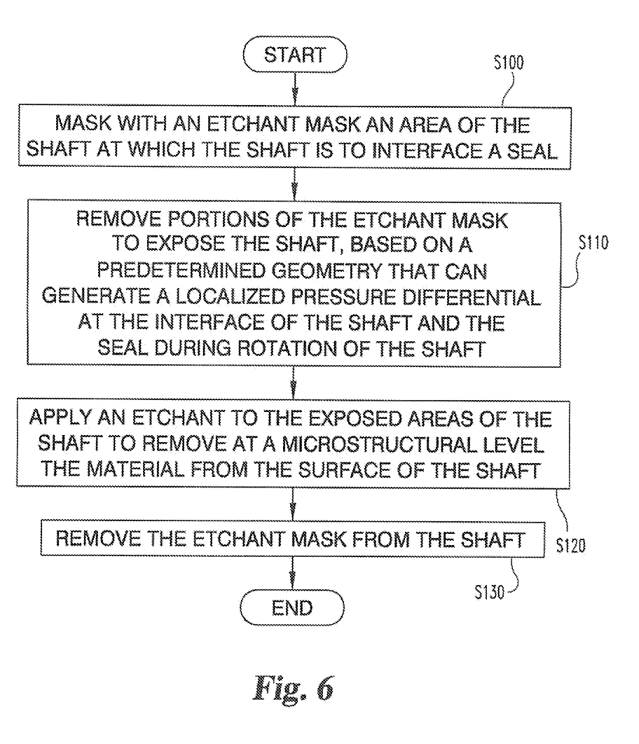

Any suitable manufacturing process for fabricating microstructural parts and components can be used to provide the microstructural geometry 38 in the surface of the shaft 12. In one embodiment, the microstructural geometry 38 is manufactured by way of a surface etching technique, for example, a chemical etching technique or electrochemical etching technique. FIG. 6 shows a flowchart of a method of fabricating a microstructural geometry 38 into the surface of a shaft 12 according to an embodiment.

Initially, the area of the shaft 12 at which the shaft 12 is to interface the seal 30 is masked with an etchant mask (S100). Etchant mask covering areas of the shaft 12 at which features such as channels or grooves of the microstructural geometry 38 are desired is removed so as to leave such areas of the shaft 12 exposed (S110). The particular arrangement of slots, grooves, channels, etc, of the geometry can be determined on the basis the geometry can generate a localized pressure differential at the interface of the shaft 12 and the seal 30 during rotation of the shaft 12. In one form, the geometry is selected based on the amount of fluid that is desired to be moved, whether pushed or pulled, at the interface of the shaft 12 and seal 30. In another form, the geometry is selected so that the localized pressure differential at the interface of the shaft 12 and the seal 30 lifts off the seal 30 from the shaft 12. Next, an etchant reagent is applied to the exposed, that is non-masked, areas to remove the material from the surface of the shaft 12 (S120). The material can be removed at a microstructural level, and the depth of material removed can be based on for example the amount of fluid that is desired to be moved at the interface of the shaft 12 and seal 30. Next, the masking is removed and the resultant microstructural geometry 38 is present in the shaft 12 (S130).

In the embodiment described above in which a seal assembly 10 is provided in an opening 18 of a housing 20 of an accessory drive gearbox of an aircraft gas turbine engine, there can be a significant amount of air-oil mist inside the gearbox. In such an embodiment, the microstructural geometry 38 in the surface of the shaft 12 is selected to generate a localized area of pressure differential that can urge movement of the air-oil mist in a particular direction at the interface between the shaft 12 and the seal 30.

Any theory, mechanism of operation, proof, or finding stated herein is meant to further enhance understanding of embodiment of the present invention and is not intended to make the present invention in any way dependent upon such theory, mechanism of operation, proof, or finding. In reading the claims, it is intended that when words such as “a,” “an,” “at least one,” or “at least one portion” are used there is no intention to limit the claim to only one item unless specifically stated to the contrary in the claim. Further, when the language “at least a portion” and/or “a portion” is used the item can include a portion and/or the entire item unless specifically stated to the contrary.

While embodiments of the invention have been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein of by any of the following claims are desired to be protected. It should also be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow.

What is claimed is:

1. A fluid sealing assembly comprising
a shaft including a surface portion having a microstructural geometry, and
a seal having a radially flexible portion disposed in proximity to the surface portion having the microstructural geometry such that when the shaft is rotated a pressure differential is generated at an interface of the seal and the surface portion having the microstructural geometry that pushes or pulls fluid relative to the interface,

2. The fluid sealing assembly of claim 1, wherein the surface portion has a microstructural geometry such that when the shaft is rotated the pressure differential pumps a buffer of fluid across the seal.

3. The fluid sealing assembly of claim 1, wherein the surface portion has a microstructural geometry such that when the shaft is rotated the pressure differential pumps a buffer of fluid between the surface portion of the shaft and the seal to dynamically lift off the seal from an outside diameter of the shaft.

4. The fluid sealing assembly of claim 1, wherein the surface portion has a microstructural geometry such that when the shaft is rotated the pressure differential adds buffer fluid into the interface of the seal and the surface portion having the microstructural geometry.

5. The fluid sealing assembly of claim 1, wherein the surface portion has a microstructural geometry such that when the shaft is rotated the pressure differential removes buffer fluid from the interface of the seal and the surface portion having the microstructural geometry.

6. The fluid sealing assembly of claim 1, wherein the shaft includes one or more of a metallic material, a non-metallic material, and a ceramic composite material.

7. The fluid sealing assembly of claim 1 wherein the seal includes one or more of natural rubber, synthetic rubber, polymeric materials, and composite materials.

8. The fluid sealing assembly of claim 1, wherein the radially flexible portion comprises a single lip portion.

9. The fluid sealing assembly of claim 1, further comprising a garter spring disposed in a recess within a body of the seal and radially outside the radially flexible portion of the seal.

10. The fluid sealing assembly of claim 1 further comprising a circumferential alignment ring that aligns a body of the seal circumferentially with respect to the shaft.

11. An accessory gearbox comprising
a housing defining an interior portion and including a shaft opening,
an annular seal at an inner perimeter of the shaft opening, and
a shaft extending from the interior portion of the housing and into the annular seal, wherein a circumferential portion of a surface of the shaft located radially inward of the annular seal includes a microstructural geometry that generates, when the shaft is rotated, a localized area of pressure differential that urges movement of fluid at an interface of the annular seal and the shaft.

12. The accessory gearbox of claim 11, wherein the localized area of pressure differential moves the fluid at the interface of the annular seal and the shaft in a predetermined direction based on the microstructural geometry in the circumferential portion of the shaft.

13. The accessory gearbox of claim 12, wherein the predetermined direction of movement of the fluid is toward the interior portion of the housing.

14. The accessory gearbox of claim 11, further comprising a fluid, wherein the fluid comprises an air-oil mist.

15. The accessory gearbox of claim 11, wherein the localized area of pressure differential generates a buffer of fluid at the interface.

16. A method of fabricating a microstructural geometry into the surface of a shaft comprising
masking with an etchant mask an area of the shaft at which the shaft is o interface a seal,
removing portions of the etchant mask to expose the shaft, wherein the removing is based on a predetermined geometry that can generate a localized pressure differential at the interface of the shaft and the seal during rotation of the shaft,
applying an etchant to exposed areas of the shaft to remove at a microstructural level material from the surface of the shaft, and
removing the etchant mask from the shaft.

17. The method of claim 16, wherein the predetermined geometry is selected based on an amount of fluid that is to be moved at the interface of the shaft and seal.

18. The method of claim 16, wherein the predetermined geometry is selected based on whether the fluid is to be pushed or pulled at the interface of the shaft and seal.

19. The method of claim 16, wherein the predetermined geometry is selected so that the localized pressure differential at the interface of the shaft and the seal lifts off the seal from the shaft.
